(19) United States
(12) Patent Application Publication
(10) Pub. No.: US 2022/0324710 A1
(43) Pub. Date: Oct. 13, 2022

(54) PROCESS AND APPARATUS FOR CONCENTRATING HYDROGEN PEROXIDE TO 98 WT.% OR MORE

(71) Applicant: SolvGE B.V., Delft (NL)

(72) Inventors: Botchu Vara Siva JYOTI, Delft (NL); Jaime QUESADA MANAS, Delft (NL); Pranav Gurumallappa PRASAD, Delft (NL)

(73) Assignee: SolvGE B.V., Delft (NL)

(21) Appl. No.: 17/775,065

(22) PCT Filed: Oct. 22, 2020
(86) PCT No.: PCT/NL2020/050653

§ 371 Date: May 6, 2022

(30) Foreign Application Priority Data
Nov. 13, 2019 (NL) 2024229

(51) Int. Cl. C01B 15/013; B01D 3/34

(52) U.S. Cl. CPC C01B 15/013; B01D 3/346

(57) ABSTRACT

The present invention is in the field of a method for obtaining high purity hydrogen peroxide, as well as a production unit for obtaining high purity hydrogen peroxide. It concerns a method for obtaining high purity hydrogen peroxide comprising the steps of providing an open container with an aqueous fluid comprising hydrogen peroxide, putting the open container with the aqueous fluid in a closed space, at ambient conditions providing an inert gas flow over and in contact with the aqueous fluid, removing water from the aqueous fluid at said ambient conditions by said gas flow, and thereby concentrating the hydrogen peroxide. The invention also concern a production unit for use in said method.

### FIELD OF THE INVENTION

The present invention is in the field of a method for obtaining high purity hydrogen peroxide, as well as a production unit for obtaining high purity hydrogen peroxide. In principle the present method and production unit are applicable to further chemical species as well, such as those that dissolve well in water.

### BACKGROUND OF THE INVENTION

Hydrogen peroxide is a chemical compound with the formula H₂O₂. It has many applications, such as for bleaching, as an oxidizer, and as an antiseptic. Concentrated hydrogen peroxide is difficult to obtain. For chemical purposes typically se is made of the unstable peroxide bond. As a consequence, hydrogen peroxide slowly decomposes.

Hydrogen peroxide can be produced through various chemical routes, wherein it is typically extracted in a final step of the process. Hydrogen peroxide is typically available as a solution in water, hence diluted. For consumers it is usually available in low concentrations (˜5 wt. %). For laboratories higher concentrations (˜30 wt. %) may be used. Commercial grades above 70% may also be available, but these pose certain risks. Therefore, most production relates to a concentration of 70% or less.

There are various process and production units that achieve higher concentrations, such as up to 95% or more. These may involve distillation units, membranes, chemicals, desiccants, sorbents for water, low pressures of typically <10 kPa, elevated temperatures, and combinations thereof. The obtained hydrogen peroxide is typically prone to some extent of disintegration and/or reaction.

Production of hydrogen peroxide, and purification thereof typically makes use of expensive systems and processes, such as in terms of energy consumption, e.g. at an elevated temperature, chemical consumption, such as catalyst consumption, high pressures, use of a resin, use of a membrane, complex installations, and so on. In addition, thereto also expensive systems and processes are used, possibly in addition to the above. the concentration of the obtained hydrogen peroxide is typically rather low, such as up to 70% or so. Thereto also Such is a concentration is acceptable for many applications, but the present invention is aimed at achieving much higher concentrations.

So prior art methods for concentrating hydrogen peroxide employ complex concentration techniques. For instance, membranes for filtration process, active reagents, external sources of energy, such as temperature and pressure, and other chemical catalysts are used, sometimes in conjunction. Hence these processes require a series of complex steps and vast amounts of infrastructure to set up. These methods can also sometimes take long to achieve the increased hydrogen peroxide levels, such as longer than 48 hours, and are often limited to a maximum concentration of 80%. These complex methods take a lot of resources and development to get implement in an efficient scale and take a large stationary production facility for it to be cost effective and viable. Once produced, this concentrated hydrogen peroxide must be then transported to the required facilities which possess additional hazards arising from the highly flammable nature and instability issues with concentrated hydrogen peroxide. Due to the complex nature of the current methods, sometimes the yield obtained of the concentrated product is low per unit volume input, and hence is inefficient. The usage of these complex processes is also harmful to the environment due to exhaust gasses formed from the various reactions during the concentration products. If membranes, catalysts, reagents or other chemicals are used in the concentration process, there is copious amounts of waste material that needs to expelled and these wastes can be reactive with the environment and hence will need treatment themselves to make them less potent. This introduces additional costs and complexities into the production process. The current methods can also be dangerous to the labour forces that are concentrating the solution as higher concentrations are more likely to corrode complex equipment over repeated use and may cause harmful leakages or explosions. Concentration techniques that require an external source of energy such as temperature, lead to instabilities of the hydrogen peroxide and hence can also cause leakages or explosions.

An example thereof is DE 36 32 245 A1. Therein a method is recited for concentrating aqueous solutions from production processes and an apparatus is disclosed for carrying out the method. The method steps comprise the particular aqueous solution flowing through at least one tank in the course of a circulation and the surface of the volume of solution situated in the tank being exposed to an air stream which is heated, i.e. energy is supplied, by so-called heat accumulated at the top in closed chambers. The apparatus comprises a plurality of flat tanks stacked one above the other, to which an aqueous solution is fed from a main vessel by a feed pump. The solution flows by gravity back into the main vessel and on passing through the tanks is exposed to an air stream which is generated by a fan and is heated by the heat accumulated at the top. The air stream serves as a heat source for vaporising the solution and for transporting away the evaporated portions of the solution. The document is silent on the hydrogen peroxide solutions, as it relates to salt solutions, and no results are given. As mentioned, heated air is used, the air not being an inert gas.

WO 2005/113428 A1 recites methods for concentrating hydrogen peroxide solutions. The methods utilize a polymeric membrane separating a hydrogen peroxide solution from a sweep gas or permeate. The membrane is selective to the permeability of water over the permeability of hydrogen peroxide, thereby facilitating the concentration of the hydrogen peroxide solution through the transport of water through the membrane to the permeate. By utilizing methods in accordance with the invention, hydrogen peroxide solutions of up to 85% by volume or higher may be generated at a point of use without storing substantial quantities of the highly-concentrated solutions and without requiring temperatures that would produce explosive mixtures of hydrogen peroxide vapors.

Some methods include using complex reagents, such as magnesium chlorate, and sodium salts to concentrate and purify the aqueous solution. These might lead to some impurities in the concentrated hydrogen peroxide.

The present invention therefore relates to an improved method for economical and simplified in-situ concentration of >90 wt. % hydrogen peroxide, which solves one or more of the above problems and drawbacks of the prior state-of-the-art, providing reliable results, without jeopardizing functionality and advantages.

### SUMMARY OF THE INVENTION

It is an object of the invention to overcome one or more limitations of the methods of the prior art and at the very least to provide an alternative thereto. In a first aspect, the invention relates to a method for obtaining high purity hydrogen peroxide comprising of providing an open container with an aqueous fluid comprising hydrogen peroxide, putting the open container with the aqueous fluid in a closed space, at ambient conditions providing an inert gas flow over and in contact with the aqueous fluid, removing water from the aqueous fluid at said ambient conditions by said gas flow, and thereby concentrating the H₂O₂. The term “inert gas” is used in its normal meaning, namely a gas that does not undergo chemical reactions under a set of given conditions; for the present invention this is the contact with either water or hydrogen peroxide. The term “high purity” [chemical] is used in its normal meaning, namely a chemical compound with virtually no impurities, and thus a purity of typically at least 90%, and if possible of at least 99%, and often at least 99.5% or more. It has been found that with said method concentration of hydrogen peroxide is obtained in relatively short time periods, under ambient condition, and to very high concentrations, of >90 wt. % hydrogen peroxide, and typically to >98 wt. % hydrogen Peroxide and more, in an economical, simple, fast, user-friendly, and accurate manner. Such can be done in the absence of further features, such as chemicals. The present invention leaves the purity of the feedstock unaltered, making the desired purity a function of the initial feedstock.

An advantage of the present invention is that it can be used for any mixture of chemicals. Nitrogen is inert and can be extracted from the atmosphere. Since the gas is inert it can be released back into the atmosphere without any problem. No chemicals, no membrane, and no heat, are used in the process. Therefore the purity of the chemical is unaltered. A direct interaction between the inert gas and the surface of the chemical solution is provided, without any medium in between (e.g. no membranes). It is noted that using dry-air would cause the chemical surface to react with the oxygen, and other gasses to react with the H₂O₂, which can lead to decomposition of H₂O₂ to lower concentrations and can even lead to explosions. It is noted that H₂O₂ is highly sensitive to foreign particles and impurities, hence dry air can not being used.

In a second aspect the present invention relates to a production unit comprising a concentration chamber 4, in the reaction chamber an open container 3 for receiving aqueous fluid, an aqueous fluid supply 5 in fluid connection with a source of aqueous fluid and the open container in the reaction chamber, an aqueous fluid outlet 6 in fluid connection with a fluid receiver and the open container in the reaction chamber, a gas supply in fluid connection with a source of inert gas 1 and the reaction chamber, a valve 2 for regulating an inflow of inert gas, optionally at least one valve 8 for regulating an outflow of inert gas, and optionally a controller 7. So, with a very simple production unit an economical, simple, fast, user-friendly, and accurate manner, and typically portable, and stand-alone, way of obtaining highly concentrated hydrogen peroxide is provided. The production unit and present method provide the availability of hydrogen peroxide for any small/medium scale research project, as well as a quick route to obtaining the chemical for larger companies.

This invention relates to a method of concentrating hydrogen peroxide in a simplified, safe, economical and portable manner, particularly, an innovative way to concentrate hydrogen peroxide from e.g. 10% to 98% or above within a duration of e.g. 45 hours. The invention uses an inert gas to cause removal of water from an aqueous solution of hydrogen peroxide, thereby concentrating the hydrogen peroxide solution. It typically uses no active input of energy in terms of pressure, temperature, electrical voltage, catalysts, membranes, reagents, chemicals or force. From an aqueous solution of hydrogen peroxide, which implies, a solution of hydrogen peroxide and water, the water molecules are extracted leaving behind the hydrogen peroxide, hence concentrating it. In an example the invention (FIG. 1) uses a source of inert gas 1 that is regulated by a control valve 2. Every further reference of the presence of a control valve is depicted by the same as 2. The supply may be regulated to the internal concentration chamber 4, where the hydrogen peroxide is concentrated. The glass dish 3 is held in place by mountings surrounded by absorbent material, where the required amount of hydrogen peroxide that is to be concentrated, is placed. The size of the exposed surface area of the dish may be a parameter controlled by the user, depending on the required volume and concentration output. Hydrogen peroxide can be poured into this dish by using the inlet line 5, adjustable in height. Once the intended amount that is to be concentrated is added to the dish, the inlet can be raised to prevent obstruction of the incoming flow of inert gas into the chamber. The outlet line 6 shows how, once concentrated, hydrogen peroxide can be extracted from the chamber and can be analysed and used. Two more control valves 8 may be present, to control the rate of outflow of the inert gas in the chamber. Such ensures the capability to control the mass flow of the inert gas into the chamber, which can be varied depending on the amount of concentrated hydrogen peroxide required. The required flow rate, duration of flow and exposed surface area is typically dependent on the volume of hydrogen peroxide required to be concentrated and the final concentration required for end application. The duration is found to scale directly with the final concentration required, as shown by the graph (FIG. 2). This inert gas outflow is then passed onto the external dynamic air environment, where inlet of air is controlled by 7 and another control valve and is passed to the air environment 9 and expelled by outlet valve 10. This ensures that there is no accumulation of inert gasses occurring outside the chamber. The mass flow in the external dynamic air environment is also found dependent directly on the rate of flow of the inert gas. The duration of concentration is dependent on the volume being concentrated, on the flow of the inert gas, on the exposed surface area, and on the required concentration increase. If the required concentration is higher, a longer duration of inert gas flow is required. As described above, the system uses no external source of energy, can occur at room (ambient) temperature, and requires no mechanical labour, hence dramatically simplifying the production procedure. This method also is eco-friendly given that most inert gasses do not contribute to air pollution, and is economical considering the simple hardware required to setup the invention. The system is also portable as the concentration chamber can be transported with ease and the moving air environment can be setup with the most basic resources. This provides a way of in-situ method of concentration of hydrogen peroxide and hence removes the problems of storage and transportation of hydrogen peroxide. This system can also be scaled to a smaller or larger size depending on the volume of hydrogen peroxide required to be produced. The present system requires minimum development cost as it is a passive system with a minimum number of moving parts. As the concentrated hydrogen peroxide does not pass through any complex equipment, there is less servicing and inspection required to ensure safety. This system is not stationary and can be set up at any location where concentrated peroxide is required. This ensures that storage and safety hazards are skipped as the concentrated hydrogen peroxide can just be made whenever needed in the required quantities and do not need to be stored and transported between manufacturing and consumer/user facilities.

So, the present invention provides a radical way to concentrate hydrogen peroxide using minimal external resources and in a safe user environment. As no chemical reagents, external heat, high-pressure environment, or purification/distillation is required, the present method provides an entirely new approach for concentration of hydrogen peroxide. Prior art methods struggle to obtain concentrations higher than 75% to 85%, and hence the present method provides a radical new way to reach concentrations even higher than 95%. Such concentrations of hydrogen peroxide can be used in pesticide products, pharmaceutical industry, clothing industry, chemical industry, cosmetics, food processing, medicine, insecticides, pesticides, packaging, space industry, and defence industry, such as a rocket propellant. The results of hypergolicity and fuel ignition using the oxidizer and fuel combinations were obtained, applicable for multiple space missions, including defence. The results achieved by using the invention allowed to obtain hydrogen peroxide to concentrations in excess of 98% in a period less than 45 hours, as seen in FIG. 2. Passing through the intermediate points of all concentrations in a continuous way, which allows this invention to select any specific hydrogen concentration over 10% by simply varying the duration.

Advantages of the present description are detailed throughout the description.

### DETAILED DESCRIPTION OF THE INVENTION

In an exemplary embodiment of the present method the inert gas may be >95% pure, preferably >99% pure, more preferably >99.5% pure, such as >99.8% pure, e.g. having less than 10 ppm impurities. Therewith a stable solution of concentrated hydrogen peroxide is obtained.

In an exemplary embodiment of the present method the inert gas may be selected from nitrogen, a noble gas, such as He, and Ar, carbon dioxide, and combinations thereof. Therewith a stable solution of concentrated hydrogen peroxide is obtained.

In an exemplary embodiment of the present method the aqueous fluid may comprise 1-99 wt. % water, preferably 5-98 wt. % water, more preferably 10-97 wt. % water, even more preferably 20-96 wt. % water, such as 50-95 wt. % water.

In an exemplary embodiment of the present method the aqueous fluid may comprise 1-85 wt. % hydrogen peroxide, preferably 2-50 wt. % hydrogen peroxide, more preferably 3-40 wt. % hydrogen peroxide, even more preferably 4-30 wt. % hydrogen peroxide, such as 10-20 wt. % hydrogen peroxide.

The present aqueous fluid typically comprises water and hydrogen peroxide, together typically forming >90 wt. % of the fluid, preferably >95 wt. %, such as >99 wt. %, and only small or tiny amounts of further compounds, typically inevitable, such as impurities, such as <2 wt. %, preferably <1 wt. %, such as <0.2 wt. %.

So, with relatively low amounts of hydrogen peroxide, and likewise high amounts of water, the present method and production unit are capable of increasing the hydrogen peroxide concentration significantly, by removing said water, such as by evaporation. It is noted that prior art methods typically are limited to a maximum of 70% hydrogen peroxide, and sometimes with extreme efforts higher concentrations might be obtained.

In an exemplary embodiment of the present method the water may be removed during a period of 1-1000 hours, preferably 2-350 hours, more preferably 3-170 hours, such as 20-40 hours. Such is much quicker than typical prior art methods. The present method does require some time to remove most or all of the water, but this is considered acceptable as during the method a system or production unit in use can be left alone.

In an exemplary embodiment of the present method ambient conditions may be at a temperature of below 45° C., preferably 10-40° C., more preferably 15-30° C., such as 16-24° C. No heating is required, and hence costs of energy are minimal.

In an exemplary embodiment of the present method ambient conditions may be at a pressure of 15-700 kPa, preferably 35-500 kPa, more preferably 70-400 kPa, such as 100-300 kPa. The gas flow may be provided at a slight under-pressure, at about ambient pressure (100 kPa), or at a slightly elevated pressure. Such may be controlled and regulated by one or more valves.

In an exemplary embodiment of the present method ambient conditions may be in the absence of a catalyst.

In an exemplary embodiment of the present method ambient conditions may be in the absence of a voltage.

In an exemplary embodiment of the present method ambient conditions may be in the absence of a membrane.

In an exemplary embodiment of the present method ambient conditions may be in the absence of a reagent.

In an exemplary embodiment of the present method ambient conditions may be in the absence of a driving force.

In an exemplary embodiment of the present method ambient conditions may be in the absence of addition of thermal energy.

In an exemplary embodiment the method may be in-situ.

Other than many prior art methods for the present method only an open container, typically of glass, a closed space, such as a vessel, some valves, and inert gas are used.

In an exemplary embodiment the present method may be a combination of the above and/or below.

In an exemplary embodiment of the present method for a volume of 1-10 litre aqueous fluid the flow of inert gas may be 1-1000 ccm/min, preferably 10-500 ccm/min, such as 100-200 ccm/min.

In an exemplary embodiment of the present method flow of inert gas may be controlled by at least one valve.

In an exemplary embodiment of the present method flow of gas may be provide over a surface of the aqueous fluid, wherein said surface has a surface area of >100 cm².

In an exemplary embodiment of the present method a surface of the fluid (m²):volume of the fluid (m³) ratio may be >10⁻³/m, preferably >10⁻²/m, such as >0.1/m.

In an exemplary embodiment of the present method hydrogen peroxide may be concentrated to a purity of >90 wt. %, which is already higher than disclosed in the prior art, preferably to >95 wt. %, more preferably to >97 wt. %, such as >98 wt. %. Typically concentrating may be perfumed at a rate of 50-1000 ccm/sec inert gas per 100 cm² hydrogen peroxide solution surface, preferably 70-500 ccm/sec, more preferably 100-300 ccm/sec, for a period of 1-96 hours, preferably 2-48 hours, more preferably 4-24 hours.

In an exemplary embodiment the present production unit is stand-alone.

The invention will hereafter be further elucidated through the following examples which are exemplary and explanatory of nature and are not intended to be considered limiting of the invention. To the person skilled in the art it may be clear that many variants, being obvious or not, may be conceivable falling within the scope of protection, defined by the present claims.

### SUMMARY OF THE FIGURES

FIGS. 1, 2a-b, and 3-6 show experimental details of the present invention. FIGS. 7-8 show examples of the present device.

### DETAILED DESCRIPTION OF FIGURES

In the figures:
1 source of inert gas
2 valve
3 open container
4 concentration chamber
an aqueous fluid supply
6 an aqueous fluid outlet
7 controller
8 valve
9 outlet
10 outlet

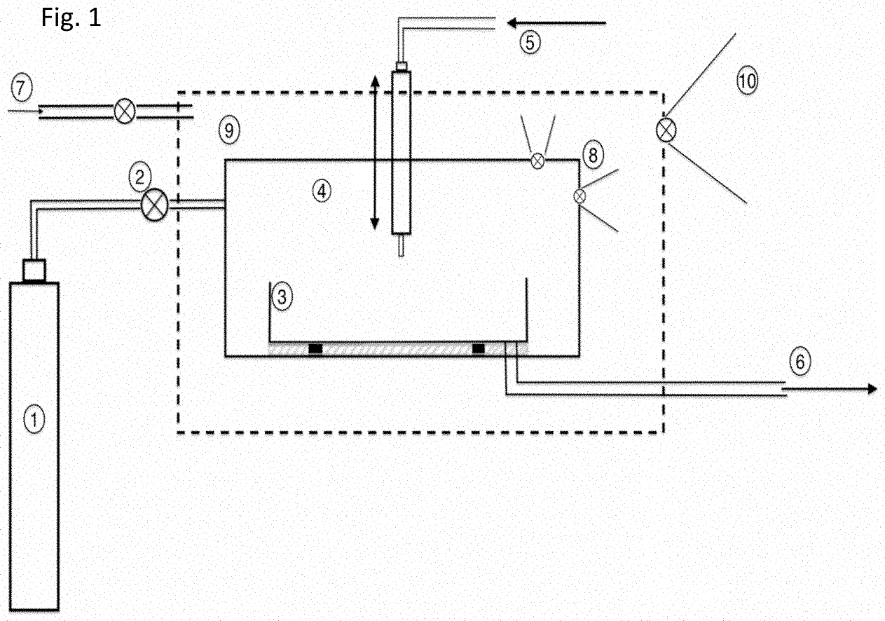

FIG. 1 shows an experimental layout of the present production unit. Therein a concentration chamber 4 (Alpha Nanotech type) is shown. In the concentration chamber an open container 3 for receiving aqueous fluid is provided. Further an aqueous fluid supply 5 in fluid connection (Goodfellow PP) with a source of aqueous fluid (Merck H₂O₂ 30%) and the open container in the reaction chamber for addition of the aqueous fluid comprising hydrogen peroxide is shown. Also an aqueous fluid outlet 6 in fluid connection with a fluid receiver and the open container in the reaction chamber is provided for removing hydrogen peroxide. A gas supply in fluid connection with a source of inert gas 1 (Anest Iwata) and the reaction chamber is further shown. Various valves 2 (Honeywell 67-7258) for regulating an inflow of inert gas may be present. And also at least one valve 8 for regulating an outflow of inert gas, and a controller 7 are shown.

Below is a short list of components used:

Nitrogen Gas generator, producing 99.5% pure N₂, operating pressure: 2.5 Bar, operating Temperature: 20 degrees Celsius; Feedstock aqueous Hydrogen Peroxide, Hydrogen Peroxide 30%, EMSURE, ISO Sigma-Aldrich, CAS Number: 7722-84-1; concentration Dish 3 of Borosilicate glass, tubes of polypropylene, External Dynamic Air Environment Chamber 9 made of Poly-acetic acid.

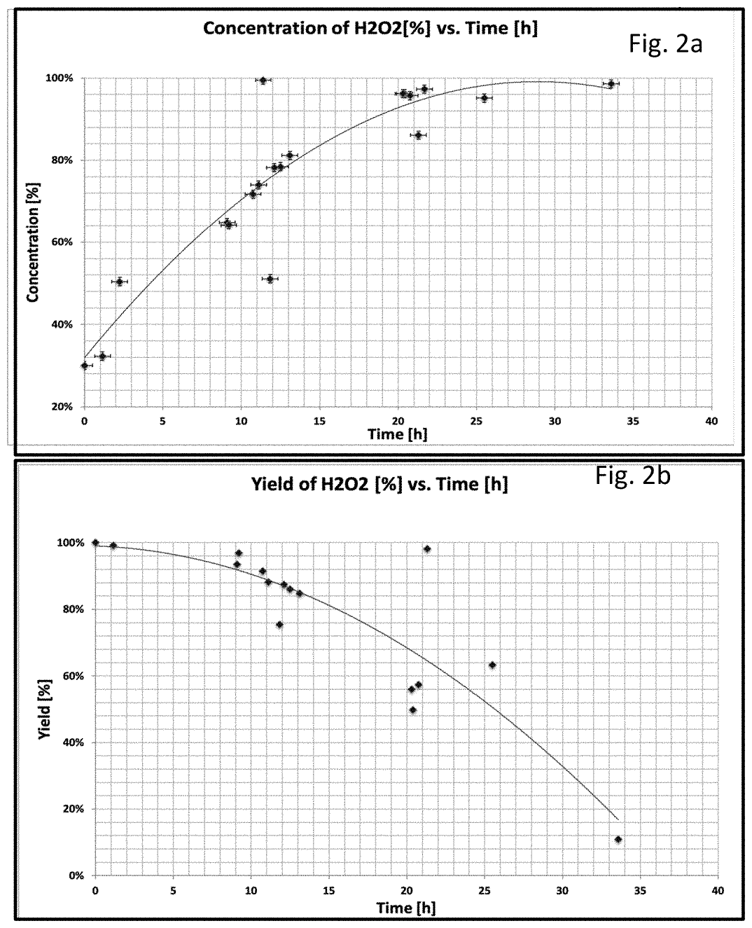

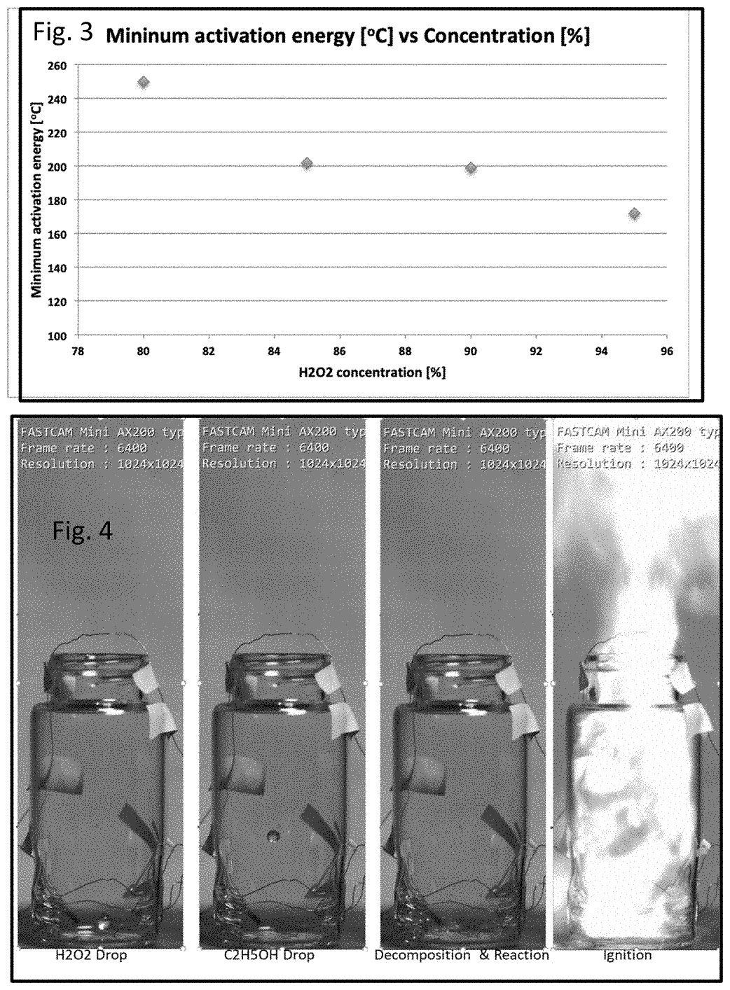

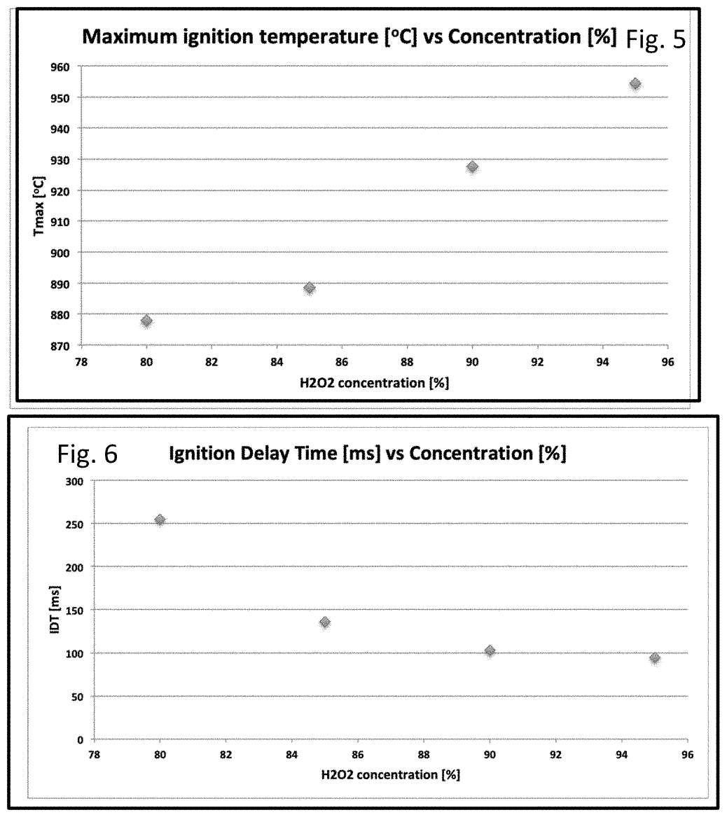

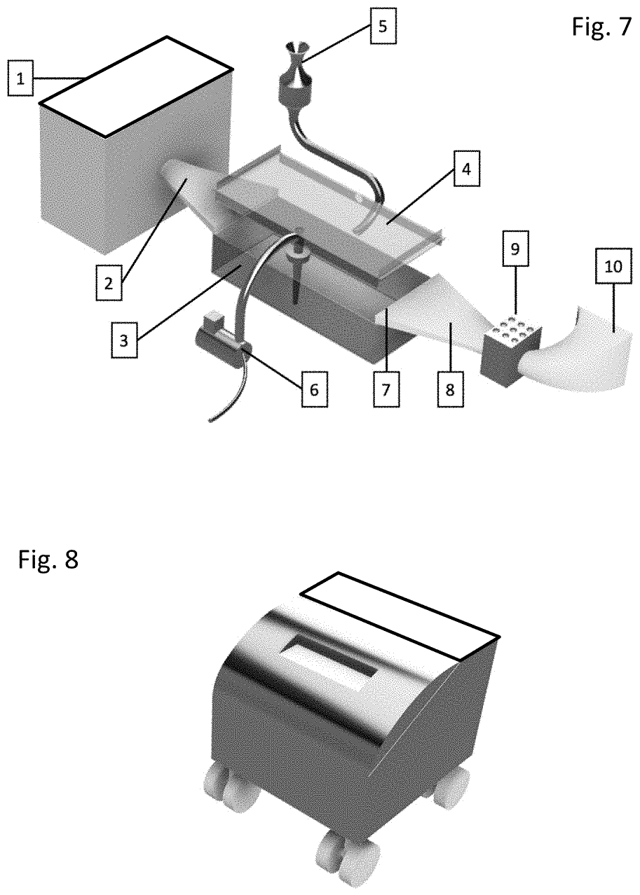

FIG. 2a. Concentration vs time, concentration as result from refractive index measurement with Abbe refractometer.

FIG. 2b. Yield calculation of output solution. Result from initial weight and concentration vs final weight and concentration. Values from refractive index.

Inventors have now obtained H₂O₂ concentrations of up to 99.5%+, and would now like to include this in the patent application. They have updated the concentration and time graphs as shown in FIG. 2a-b. The time required to reach the higher concentrations has significantly reduced.

FIG. 3. Minimum activation energy to initiate decomposition vs H₂O₂ concentration.

FIG. 4. Ignition of concentrated H₂O₂ aqueous solution with Ethanol fuel.

FIG. 5. Ignition temperature vs H₂O₂ concentration.

FIG. 6. Ignition delay time vs H₂O₂ concentration.

FIG. 7 shows a first commercial version of the present apparatus, and FIG. 8 shows the present small stand-alone version. The inlet is to provide inert gas into the chamber. Here the water is extracted with the gas, and is then pushed through the outlet. This is a continuous process where the inert gas enters the H₂O₂ chamber and water is extracted by the gas. This then flows through the outlet carrying the water and leaving behind the concentrated H₂O₂. The source of the inert gas can be a gas storage cylinder or can be a system that extracts the inert gas straight from the atmosphere, or a combination of both. Therein the inert gas is passed over the H₂O₂. In the exit through 8, 9 and 10 the water is extracted from the inert gas and the inert gas is expelled back into the atmosphere, without having undergone any reaction itself (that is, inert gas composition remains the same). The gas may also be recirculated and reused to concentrate the H₂O₂. FIG. 8 shows the design of the final product that is presently being built. The user thereof will be able to collect any concentration H₂O₂ from this product, and along with wheels can ensure a high level of portability.

Experiment

Description of Production Unit Operation (FIG. 1)

This production unit comprises at least two main inputs, one for aqueous hydrogen peroxide (5), and one for an inert gas supply (1). The production unit is for purifying (hence concentrating) H₂O₂. The input of the feedstock hydrogen peroxide was provided at an initial concentration, which might be as low as 5 to 10% H₂O₂ aqueous solution) and volume that is required to be concentrated. This aqueous H₂O₂ in an amount of e.g. 2 is introduced into the concentration chamber (shown by 4 in FIG. 1) through the feed line (shown by 5 in FIG. 1). This concentration chamber consists of an open container, such as a concentration dish (shown by 3 in FIG. 1), held in place by mountings, where the initial aqueous hydrogen peroxide is placed. After placing the initial aqueous H₂O₂ into the dish, the feed line (shown by 5 in FIG. 1) is withdrawn to ensure no obstructions for the inert gas flow. After being withdrawn, the inert gas flow was initiated at a rate of 140 ccm/sec for a period of 20 hours to remove water from aqueous H₂O₂. This is initiated by actuating a flow control valve (shown by 2 in FIG. 1), to ensure a steady flow rate of inert gas into the concentration chamber. Due to this continuous input flow, the inert gas along with removed water vapour from aqueous H₂O₂ solution passes onto the external dynamic air environment through the valves (shown by 8 in FIG. 1). The external dynamic air environment chamber (shown by 9 in FIG. 1) consists of free moving air. This free moving air enters the chamber through the inlet (shown by 7 in FIG. 1), ensuring the continuous removal of the inert gas and the water vapour from the system though a valve (shown by 10 in FIG. 1), thereby preventing the accumulation and build-up of inert gas along with water vapour around the invention unit. The flow of the inert gas into the concentration chamber can be controlled by the valve (shown by 2 in FIG. 1, e.g. Bronkhorst FC-002) and the flow of the inert gas out of the concentration chamber can be controlled by the valve (shown by 8 in FIG. 1). The flow rate of the inert gas into and out of the concentration chamber can be set arbitrarily, such as within the claimed ranges, having an effect on both speed of concentration and final yield. The final concentrations of H₂O₂ (up to 99.6%) can be selected by allowing the inert gas supply for different time durations, as claimed. From FIGS. 2a and 2b, the time required and yield percent for a particular final H₂O₂ concentration can be obtained based on user requirement. Once the desired final concentration is reached, the valves shown by 2 and 8 are closed. After the valves have been closed, the concentrated hydrogen peroxide can be sampled by the output line as shown by 6 in FIG. 1. When the satisfactory final concentration of H₂O₂ is obtained, the sample can be extracted and used.

From graphs 2a and 2b a total time required for a required concentration can be obtained. It is noted that these graphs pertain to a particular and given flow rate of inert gas (140 ml/sec). This flow rate is considered optimal for the present production unit. For a shorter duration of the concentration procedure, a fast flow rate of the inert gas could be used. But this faster flow rate could affect the percent yield of the final concentrated H₂O₂. In order to significantly improve the final yield, the flow rate may typically be optimised. This will lead to larger amounts of final concentrated H₂O₂, based on the optimised flow rate selected.

Testing

Two methods were used in different qualities to characterize the concentration of the solution. These are:

Quantitatively: refractive index with the use of Abbe refractometer in controlled conditions (20° C., 1 atm). This optical approach is used to monitor H₂O₂ concentration. In this method the following procedure was followed; the varied concentration range of H₂O₂ produced by the present invention was evaluated through refractive index of H₂O₂ droplets using an Abbe refractometer. Using this technique one can measure the concentrations of H₂O₂. First the Abbe refractometer device was calibrated with a distilled H₂O droplet followed by H₂O₂ concentrations ranging from 10% to 99.6%. Water has a refractive index of 1.33, and 100% pure H₂O₂ has a refractive index of 1.41 (at visible wavelengths of light), with aqueous solutions of H₂O₂ and water lying in between these values. As the concentration of H₂O₂ in the solution increases, it follows that the refractive index will increase, and by measuring the refractive index, it is possible to determine a concentration of H₂O₂ in a H₂O₂ aqueous solution.

Qualitatively: recording of decomposition temperature of the solution through fast recording data acquisition system (55 Hz) with k-type thermocouples. The process was initiated trough thermal activation of the solution. Monitoring the concentration of H₂O₂ in H₂O₂ aqueous solution through electrochemical redox reaction, where in the heat energy of the exothermic reaction increases with increasing H₂O₂ concentration. For this qualitative method, small amount of external source of temperature was used to increase the rate of decomposition of H₂O₂ aqueous solution.

Decomposition of concentrated H₂O₂ solutions: This approach helps to predict qualitatively the varied H₂O₂ concentrated solution decomposition with minimum input activation energy in terms of temperature. For qualitative evaluation of concentration, a H₂O₂ concentration from 80% and above have been investigated.

Evaluation 1—Decomposition Input Temperature (T_{Min}): The process was initiated with thermal activation of the H₂O₂ aqueous solution by providing a minimum input activation energy to initiate decomposition. In this evaluation experiment, single drops of varied concentrations of H₂O₂ (from 80% to 95%) were released over a thermal heating plate from a height of 17 cm. H₂O₂ droplets of 0.13 mL of volume were generated through an electronic syringe pump. As soon as the concentrated H₂O₂ droplet comes in contact with the heating plate, it undergoes rapid exothermic decomposition followed by release of energy in terms of temperature. With increase in H₂O₂ concentration (from 80% to 95% pure) the minimum input energy (T_{Min}) needed for decomposition decreases as seen in FIG. 3.

Ignition of concentrated H₂O₂ aqueous solution with fuel (Ethanol): Recording of ignition of the H₂O₂ droplet (concentration from 80% to 95%) once it comes in contact with a fuel ethanol (C2H₅OH) droplet done using a photron high speed camera at 6400 fps. The reaction starts with minimum activation thermal energy supply of 250° C. via a heating plate to the H₂O₂ droplet (0.13 mL volume) at different concentrations (80% to 95% pure) and subsequent addition of an ethanol (99.5% pure) droplet from a height of 17 cm to initiate ignition. A electronic syringe pump was used to generate H₂O₂ and Ethanol droplet. With an increase in H₂O₂ concentration, it is expected that the ignition temperature increases followed by a decrease in ignition delay time (time between first contact and the start of ignition). This is due to increased energetic content with increased H₂O₂ concentration. This trend can be seen in FIG. 4-6.

1. A method for obtaining high purity hydrogen peroxide comprising:
providing an open container with an aqueous fluid comprising hydrogen peroxide,
putting the open container with the aqueous fluid in a closed space,
at ambient conditions providing an inert gas flow over and in contact with the aqueous fluid,
removing water from the aqueous fluid at said ambient conditions by said gas flow, and thereby
concentrating the H₂O₂.

2. The method according to claim 1, wherein the inert gas is >95% pure, and is selected from nitrogen, a noble gas, carbon dioxide, and combinations thereof.

3. The method according to claim 1, wherein the aqueous fluid comprises 1-99 wt. % water, and wherein the aqueous fluid comprises 1-85 wt. % hydrogen peroxide.

4. The method according to claim 1, wherein the water is removed during a period of 1-1000 hours.

5. The method according to claim 1, wherein ambient conditions are at a temperature of below 45° C., and at a pressure of 15-700 kPa, and in the absence of a catalyst, and in the absence of a voltage, and in the absence of a membrane, and in the absence of a reagent, and in the absence of a driving force, and in the absence of addition of thermal energy, and wherein the method is in-situ, and combinations thereof.

6. The method according to claim 1, wherein for a volume of 1-10 litre aqueous fluid the flow of inert gas is 1-1000 ccm/min.

7. The method according to claim 1, wherein the flow of inert gas is controlled by at least one valve.

8. The method according to claim 1, wherein the flow of gas is provided over a surface of the aqueous fluid, wherein said surface has a surface area of >100 cm², and wherein a surface/volume ratio of the fluid is >10⁻³/m.

9. The method according to claim 1, wherein hydrogen peroxide is concentrated to a purity of >90 wt. %.

10. A production unit for use in the method of claim 1, comprising
a concentration chamber,
in the concentration chamber an open container for receiving aqueous fluid,
an aqueous fluid supply comprising hydrogen peroxide in fluid connection with a source of aqueous fluid and the open container in the reaction chamber,
an aqueous fluid outlet in fluid connection with a fluid receiver and the open container in the reaction chamber,
a gas supply in fluid connection with a source of inert gas and the reaction chamber, and
a valve for regulating an inflow of inert gas at ambient conditions.

11. The production unit according to claim 10, wherein the production unit is stand-alone.
